(19) United States
(12) Patent Application Publication
(10) Pub. No.: US 2023/0394206 A1
(43) Pub. Date: Dec. 7, 2023

(54) METHOD FOR DESIGNING FAULT DETECTION CIRCUIT

(71) Applicant: Rohm Co., Ltd., Kyoto (JP)

(72) Inventor: Kazuya IOKI, Kyoto (JP)

(21) Appl. No.: 18/317,261

(22) Filed: May 15, 2023

(30) Foreign Application Priority Data
Jun. 1, 2022 (JP) 2022-089609

(51) Int. Cl. G06F 30/31; G01R 31/28

(52) U.S. Cl. CPC G06F 30/31; G01R 31/2836; G06F 2119/02

(57) ABSTRACT

A method for designing a fault detection circuit includes an extraction step of selecting a fixed signal value based on an index, and extracting, by using the fixed signal value selected, one or some but not all of three-signal implication relationships.

### INCORPORATION BY REFERENCE

This nonprovisional application claims priority under 35 U.S.C. § 119(a) on Patent Application No. 2022-089609 filed in Japan on Jun. 1, 2022, the entire contents of which are hereby incorporated by reference.

### BACKGROUND OF THE INVENTION

### Field of the Invention

The invention disclosed herein relates to a method for designing a fault detection circuit.

### Description of the Related Art

In recent years, in the field of in-vehicle LSI (Large Scale Integration), conformity with the ISO26262 standards which provide a process for achieving functional safety of vehicles, has been becoming indispensable. To achieve the functional safety of vehicles, fault detection used as safety mechanism is very important.

In the ISO26262 standards, an index is provided that indicates, based on the magnitude of fault impact, the rate of faults even with occurrence of which safety can be avoided.

FIG. 1 is a table showing SPFM (Single-Point Fault Metric) and LFM (Latent-Fault Metric) set for each level of ASIL (Automotive Safety Integrity Level).

SPFM and LFM are indices that are not diagnostic coverage itself but are very much dependent on the diagnostic coverage of fault detection, and a target value is set for each level of ASIL.

ASIL is an index that indicates the severity of an impact when a system has fallen into a not-safe state. The severity of an impact increases in the order of ASIL B, ASIL C, and ASIL D. Thus, ASIL D indicating the highest severity inevitably requires the highest diagnostic coverage of fault detection.

In a case where a high diagnostic coverage is necessary in a continuously-monitored online test, fault detection is performed by using Dual Lock Step, for example, in which a copy of the target circuit for fault detection is made and test results are compared between the original and the copy. Further, in a case where a little low diagnostic coverage is acceptable in a continuously-monitored online test, fault detection is performed by using a code such as a parity code.

Further, in a case where the operation of a target circuit for fault detection can be stopped, it is possible to perform the fault detection by using diagnosis using software, BIST (Built-In Self-Test), or the like (see Japanese Unexamined Patent Publication No. 2020-187055, for example).

As to the conventional fault detection methods as described above, there is a limit to the diagnostic coverage that can be achieved by those methods, and thus they do not necessarily satisfy requirements of functional safety standards such as the ISO2626 standards. Thus, in a case where it is impossible to achieve such a diagnostic coverage as is necessary to satisfy requirements of functional safety standards such as the ISO26262 standards, it is necessary to introduce a fault detection method having a one-stage higher fault-detection capability even though it will require a large area overhead. That is, with only the conventional fault detection methods as described above, it is impossible to finely adjust the trade-off between area overhead and diagnostic coverage.

Against the above background, the inventor of the present invention proposed, as a technique capable of solving the above problem, a semiconductor integrated circuit device in which fault detection based on an implication relationship that holds between nets in the target circuit for fault detection and fault detection using other method are combined (see Japanese Patent Application No. 2022-18470).

Further, in the fault detection based on an implication relationship, as compared with a case of using only a two-signal implication relationship (an implication relationship between two signals), improvement can be expected in fault detection rate by using a three-signal implication relationship (an implication relationship between three signals).

However, the number of two-signal implication relationships is a function of the square of the number of signal lines, whereas the number of three-signal implication relationships is a function of the cube of the number of signal lines. Since the number of three-signal implication relationships is thus enormous, using all the three-signal implication relationships is not practical due to a very large area overhead of fault detection.

Thus, in the fault detection using three-signal implication relationships, it is necessary to select and use a three-signal implication relationship that is high in fault-detection capability.

### SUMMARY OF THE INVENTION

A method for designing a fault detection circuit disclosed herein is a method for designing a fault detection circuit configured to detect a fault in a target circuit for fault detection, the method including: an extraction step of selecting a fixed signal value based on an index, and extracting, by using the fixed signal value selected, one or some but not all of three-signal implication relationships that hold between nets in the target circuit; and a designing step of designing the fault detection circuit by selecting an implication relationship that is high in area efficiency from among the three-signal implication relationships extracted in the extraction step and a two-signal implication relationship that holds between the nets in the target circuit. Here, the extraction step includes at least one of: a first extraction step in which such ones of the three-signal implication relationships as have a fault-detection capability that is predictable from a number of faults detected by a two-signal implication relationship constitute a population for extraction, and the index is a first index which corresponds to a number of faults detected by three two-signal implication relationships; a second extraction step in which such ones of the three-signal implication relationships as have a fault-detection capability that is partly predictable from a number of faults detected by a two-signal implication relationship constitute a population for extraction, and the index is a second index which corresponds to a number of faults detected by one two-signal implication relationship; and a third extraction step in which such ones of the three-signal implication relationships as have a fault-detection capability that is unpredictable from a number of faults detected by a two-signal implication relationship constitute a population for extraction, and the index is a third index which corresponds to a number of implication relationships newly generated by the fixed signal value.

According to the invention disclosed herein, it is possible to extract a three-signal implication relationship that is high in fault-detection capability. The features and advantages of the present invention will become further apparent from the description of embodiments given below. However, the embodiments described below are merely exemplary of the invention, and the meanings of the terms for each configurational requirement of the present invention are not restricted to the description in the embodiment below.

### BRIEF DESCRIPTION OF THE DRAWINGS

FIG. 1 is a diagram showing SPFM and LFM set for each level of ASIL.

FIG. 2 is a diagram showing a logic circuit for describing direct implication.

FIG. 3 is a diagram showing a logic circuit for describing indirect implication.

FIG. 4 is a diagram showing an example of the configuration of an implication checker using a two-signal implication relationship.

FIG. 5 is a diagram showing a two-input AND gate.

FIG. 6 is a diagram showing a three-input AND gate.

FIG. 7 is a diagram showing a two-input XOR gate.

FIG. 8 is a diagram showing a three-input AND-NOR gate.

FIG. 9 is a diagram showing a four-input multiplexer.

FIG. 10A is a diagram showing a first case of a three-signal implication relationship.

FIG. 10B is a diagram showing a second case of a three-signal implication relationship.

FIG. 10C is a diagram showing a third case of a three-signal implication relationship.

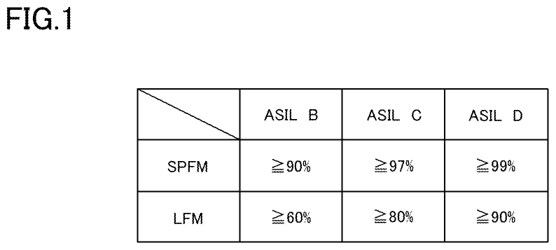

### DESCRIPTION OF THE PREFERRED EMBODIMENTS

First, a description will be given of a two-signal implication relationship. There are two methods for extracting a two-signal implication relationship that holds between nets in a circuit. One is a method that includes static learning of the configuration of a circuit, and the other is a method that uses a tool such as SAT Solver to confirm a relationship that holds in a simulation that is based on random input.

The method including the static learning of the configuration of a circuit is a method in which extraction of an implication relationship by means of direct implication and indirect implication is repeated until no more new implication relationship can be found.

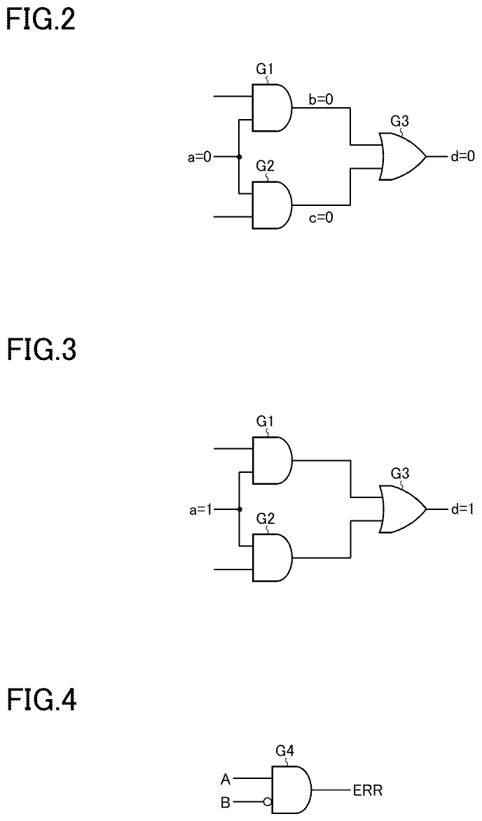

FIG. 2 is a diagram showing a logic circuit for describing direct implication. FIG. 3 is a diagram showing a logic circuit for describing indirect implication. The logic circuits shown in FIG. 2 and FIG. 3 each include AND gates G1 and G2 and an OR gate G3. To a second input terminal of the AND gate G1 and to a first input terminal of the AND gate G2, an input signal a is fed. An output terminal of the AND gate G1 is connected to a first input terminal of the OR gate G3, and an output terminal of the AND gate G2 is connected to a second input terminal of the OR gate G3. From an output terminal of the OR gate G3, an output signal d is outputted.

Direct implication is an implication obtained from input-output relationship of a logic gate and the transitive law. In the example shown in FIG. 2, by following relationships (1) and (2) below, a direct implication (3) below is extracted.

a=0→b=0,a=0→c=0 (1)

b=0C∩c=0→d=0 (2)

a=0→d=0 (3)

Indirect implication is an implication that cannot be obtained from input-output relationship of a logic gate alone. For example, in the example shown in FIG. 3, even by following an input-output relationship of the logic gate from the output terminal of the OR gate G3, it cannot be determined to which one of the first and second input terminals of the OR gate G3, a signal of “1” is fed. Then, an indirect implication can be obtained through static learning by making use of “If P→Q is true, its contrapositive \hat{ }Q→\hat{ }\hat{ }P is also true.” In the example shown in FIG. 3, an indirect implication (4) below is extracted.

d=1→a=1 (4)

The method that uses a tool such as SAT Solver to confirm a relationship that holds in a simulation that is based on random input is executed in the following steps (i), (ii), and (iii) in this order.
(i) Perform a simulation with about 32000 random input patterns, for example, and record values of all nets in a circuit.
(ii) Extract, with respect to all signal pairs, relationships that are equivalent or inverse to results of the simulation.
(iii) Confirm whether the relationships extracted in the step (ii) are correct by using a tool such as SAT Solver. Only a relationship that is confirmed to be correct by using a tool such as SAT Solver is regarded as an implication relationship.

FIG. 4 is a diagram showing an example of the configuration of an implication checker (an abnormality detection circuit) using a two-signal implication relationship. The implication checker shown in FIG. 4 includes an AND gate G4. To a first input terminal of the AND gate G4, a signal A is fed. To a second input terminal of the AND gate G4, an inverse signal of a signal B is fed. The implication checker shown in FIG. 4 confirms whether or not the implication relationship “A=1→B=1” is maintained. If the implication relationship “A=1→B=1” is maintained, an error signal ERR outputted from an output terminal of the AND gate G4 is “0”, which indicates normality. On the other hand, if the implication relationship “A=1→B=1” is not maintained due to a fault, an error signal ERR outputted from the output terminal of the AND gate G4 is “1”, which indicates a fault.

Next, a description will be given of a three-signal implication relationship. By extracting, with respect to all signals in a target circuit for fault detection, a two-signal implication relationship that holds in a case where a value of each signal is 0 and a two-signal implication relationship that holds in a case where the value of each signal is 1, it is possible to extract all three-signal implication relationships.

However, a target circuit for fault detection having a larger circuit scale has a larger number of signals therein and thus it will require a longer period of time to extract implication relationships therefrom.

Thus, according to the present embodiment, in a method for designing a fault detection circuit, there is introduced an index for selecting a fixed signal value to be used in extracting a three-signal implication relationship. By extracting one or some but not all of three-signal implication relationships that hold between nets in a target circuit for fault detection by using a fixed signal value selected based on an appropriate index, it is possible to extract a three-signal implication relationship that is high in fault-detection capability. Thereby, without extracting all the three-signal implication relationships, it is possible to design a fault detection circuit that has high fault-detection capability.

The inventor of the present invention analyzed three-signal implication relationships, and found out that many three-signal implication relationships are attributable to a new implication relationship between input and output of a logic gate caused by a fixed signal value.

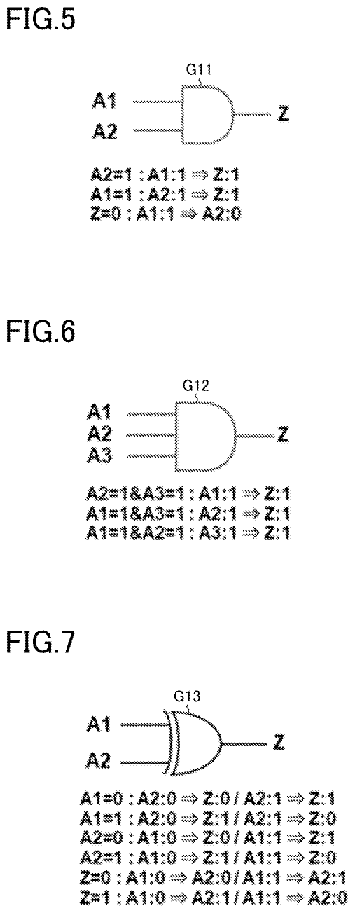

For example, between input and output ports of a two-input AND gate G11 shown in FIG. 5, there are an implication relationship “Port A1: 0→Port Z: 0” and an implication relationship “Port A2: 0→Port Z: 0”. Here, by a value of a port of the two-input AND gate G11 being fixed, that is, by using a fixed signal value, a new implication relationship is generated.

As shown in FIG. 5, with the value of the port A2 fixed to 1, a new implication relationship “Port A1: 1→Port Z: 1” is generated. Also, as shown in FIG. 5, if the value of the port A1 is fixed to 1, a new implication relationship “Port A2: 1→Port Z: 1” is generated. Also, as shown in FIG. 5, if the value of the port Z is fixed to 0, a new implication relationship “Port A1: 1→PortA2: 0” is generated.

A three-input AND gate G12 shown in FIG. 6 is an example in which a new implication relationship is generated by fixing values of two ports.

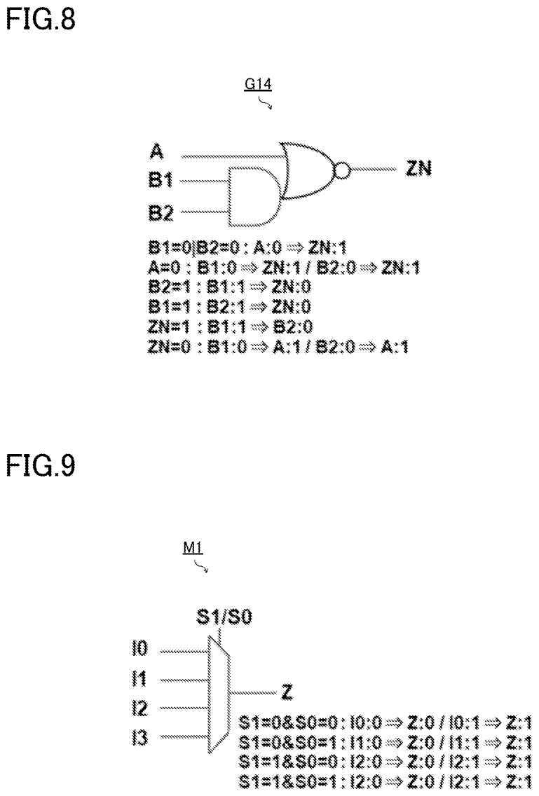

A new implication relationship is generated not only between input and output ports, but also between two input ports. The two-input AND gate G11 shown in FIG. 5, a two-input XOR gate G13 shown in FIG. 7, and a three-input AND-NOR gate G14 shown in FIG. 8 are examples where a new implication relationship is generated between two input ports.

Further, in complex logic gates such as the three-input AND-NOR gate G14 shown in FIG. 8 and a four-input multiplexer M1 shown in FIG. 9 as well, a new implication relationship is generated by a fixed signal value. Note that, in FIG. 5 to 9, contrapositive implication relationships are also true, but indication thereof is omitted for the sake of simplicity. For example, in FIG. 5, when A2=1, “Port Z: 0→Port A1: 0” is also true.

A signal value in a target circuit for fault detection that is determined by a fixed signal value will all be identified with information of a two-signal implication relationship. Thus, a new implication relationship generated between input and output of a logic gates in the target circuit for fault detection also will all be identified by referring to a rule that defines an implication relationship newly generated in each of the logic gates.

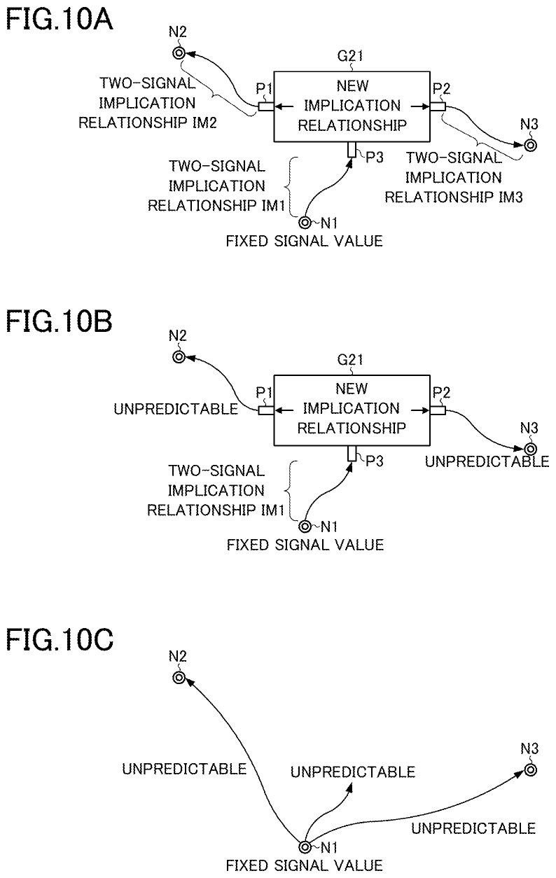

From combinations of fixed signal values and newly generated implication relationships, various three-signal implication relationships are generated. Three-signal implication relationships can be classified into three cases as shown in FIG. 10A to FIG. 10C.

A two-signal implication relationship IM1 is a two-signal implication relationship between a signal value (a fixed signal value) fixed in a net N1 in a target circuit for fault detection and a value of a third port P3 of a logic gate G21, the value of the third port P3 of the logic gate G21 serving as a condition for generating a new implication relationship between a first port P1 and a second port P2 of the logic gate G21. Note that the third port P3 may include a plurality of third ports P3. A two-signal implication relationship IM2 is a two-signal implication relationship of which a starting point is the first port P1 and of which an end point is a net N2 in the target circuit for fault detection. A two-signal implication relationship IM3 is a two-signal implication relationship of which a starting point is the second port P2 and of which an end point is a net N3 in the target circuit for fault detection.

A first case shown in FIG. 10A is a case where a fault detection capability of a three-signal implication relationship is predictable from a number of faults detected by a two-signal implication relationship.

In the first case, a number of abnormalities detected by a three-signal implication relationship that holds between the nets N1 to N3 in the target circuit for fault detection is equal to a total of numbers of abnormalities detected by the two-signal implication relationships IM1 to IM3. And, a plurality of candidates exist for the net N2, and a plurality of candidates exist for the net N3 as well.

In the method for designing a fault detection circuit according to the present embodiment, a first extraction step is executed in which three-signal implication relationships corresponding to the first case constitute a population for extraction, a fixed signal value is selected based on a first index which corresponds to a number of faults detected by the three two-signal implication relationships IM1 to IM3, and by using the fixed signal selected, one or some but not all of the three-signal implication relationships are extracted.

Specifically, the first index is an index that corresponds to the number of faults detected by the two-signal implication relationship IM1, a maximum number of faults detected by the two-signal implication relationship IM2 of which the starting point is the first port P1, and a maximum number of faults detected by the two-signal implication relationship IM3 of which the starting point is the second port P2.

More specifically, the first index is a value obtained by multiplying a total value of the number of faults detected by the two-signal implication relationship IM1, the maximum number of faults detected by the two-signal implication relationship IM2 of which the starting point is the first port P1, and the maximum number of faults detected by the two-signal implication relationship IM3 of which the starting point is the second port P2 by an occurrence probability of the fixed signal value. Here, a occurrence probability of a fixed signal value is the probability of occurrence of the fixed signal value in the net N1 when the target circuit for fault detection is in operation.

In the first extraction step, by selecting such a fixed signal value as will cause the first index to be large, a three-signal implication relationship that is high in fault-detection capability is selected from among the three-signal implication relationships corresponding to the first case. In the first extraction step, with respect to the first index, by selecting about 5% of all fixed signal values, a three-signal implication relationship that is high in fault-detection capability can be efficiently selected from among the three-signal implication relationships corresponding to the first case.

A second case shown in FIG. 10B is a case where a fault-detection capability of a three-signal implication relationship is partly predictable from a number of faults detected by a two-signal implication relationship.

In the second case, the number of faults detected by the two-signal implication relationship IM1 is reflected in the number of abnormalities detected by the three-signal implication relationships that hold between the nets N1 to N3 in the target circuit for fault detection, but a number of detected abnormalities attributable to an implication relationship newly generated between the first port P1 and the second port P2 is unpredictable from a two-signal implication relationship.

In the method for designing a fault detection circuit according to the present embodiment, a second extraction step is executed in which three-signal implication relationships corresponding to the second case constitute a population for extraction, a fixed signal value is selected based on a second index which corresponds to the number of faults detected by the two-signal implication relationships IM1, and by using the fixed signal value selected, one or some but not all of the three-signal implication relationships are extracted.

Specifically, the second index is an index that corresponds to the number of faults detected by the two-signal implication relationship IM1.

More specifically, the second index is a value obtained by multiplying the number of faults detected by the two-signal implication relationship IM1 by the occurrence probability of the fixed signal value.

In the second extraction step, by selecting such a fixed signal value as will cause the second index to be large, a three-signal implication relationship that is high in fault-detection capability is selected from among the three-signal implication relationships corresponding to the second case. In the second extraction step, with respect to the second index, by selecting about 5% of all fixed signal values, a three-signal implication relationship that is high in fault-detection capability can be efficiently selected from among the three-signal implication relationships corresponding to the second case.

A third case shown in FIG. 10C is a case where a fault-detection capability of a three-signal implication relationship is unpredictable from a number of faults detected by a two-signal implication relationship.

In the method for designing a fault detection circuit according to the present embodiment, a third extraction step is executed in which three-signal implication relationships corresponding to the third case constitute a population for extraction, a fixed signal value is selected based on a third index which corresponds to a number of implication relationships newly generated by the fixed signal value, and by using the fixed signal value selected, one or some but not all of the three-signal implication relationships are extracted. Specifically, the third index is a value obtained by multiplying the number of newly generated implication relationships by the occurrence probability of the fixed signal value.

In the third extraction step, by selecting such a fixed signal value as will cause the third index to be large, a three-signal implication relationship that is high in fault-detection capability is selected from among the three-signal implication relationships corresponding to the third case. In the third extraction step, with respect to the third index, by selecting about 5% of all fixed signal values, a three-signal implication relationship that is high in fault-detection capability can be efficiently selected from among the three-signal implication relationships corresponding to the third case. Note that “about 5%” mentioned above is a mere example, and it can be thought that, depending on a target circuit, there may be a case where the percentage can be much smaller or larger than that.

Further, in the method for designing a fault detection circuit according to the present embodiment, a designing step is executed in which a fault detection circuit is designed by selecting such implication relations as are high in area efficiency from among the three-signal implication relationships extracted in the first to third extraction steps and a two-signal implication relationship that holds between the nets in a target circuit. Thereby, an implication checker (an abnormality detection circuit) is designed in which the three-signal implication relationships extracted in the first to third extraction steps are used. In the designing step, for example, selection is repeated, in order of area efficiency starting from an implication relationship with the highest area efficiency, until an area of the fault detection circuit reaches a predetermined value. Note that the area efficiency of an implication relationship is a rate of errors detected by the implication checker using the implication relationship with respect to a circuit area of the implication checker using the implication relationship.

The first to third extraction steps and the designing step are executed by an information processing device, for example.

In addition to the embodiments described above, the configuration of the present invention can be modified in many different forms without departing from the scope of the present disclosure. It should be understood that the foregoing embodiments are not limitative but illustrative in every respect, and that the technical scope of the present invention is not determined by the foregoing embodiments but by the claims, and should be construed to include all modifications equivalent in meaning and scope to the claims.

In the above embodiments, the first to third extraction steps are executed, but instead, only one of the first to third extraction steps may be executed, or only two of the first to third extraction steps may be executed. Note that, however, with more of the first to third extraction steps executed, more various types of target circuits can be dealt with.

The above-discussed method for designing a fault detection circuit is a method for designing a fault detection circuit configured to detect a fault in a target circuit for fault detection, the method including: an extraction step of selecting a fixed signal value based on an index, and extracting, by using the fixed signal value selected, one or some but not all of three-signal implication relationships that hold between nets in the target circuit; and a designing step of designing the fault detection circuit by selecting an implication relationship that is high in area efficiency from among the three-signal implication relationships extracted in the extraction step and a two-signal implication relationship that holds between the nets in the target circuit. Here, the extraction step includes at least one of: a first extraction step in which such ones of the three-signal implication relationships as have a fault-detection capability that is predictable from a number of faults detected by a two-signal implication relationship constitute a population for extraction, and the index is a first index which corresponds to a number of faults detected by three two-signal implication relationships; a second extraction step in which such ones of the three-signal implication relationships as have a fault-detection capability that is partly predictable from a number of faults detected by a two-signal implication relationship constitute a population for extraction, and the index is a second index which corresponds to a number of faults detected by one two-signal implication relationship; and a third extraction step in which such ones of the three-signal implication relationships as have a fault-detection capability that is unpredictable from a number of faults detected by a two-signal implication relationship constitute a population for extraction, and the index is a third index which corresponds to a number of implication relationships newly generated by the fixed signal value (a first configuration).

The method for designing a fault detection circuit according to the first configuration makes it possible to extract a three-signal implication relationship that is high in fault-detection capability.

In the method for designing a fault detection circuit according to the first configuration, the extraction step may include at least two of the first extraction step, the second extraction step, and the third extraction step (a second configuration).

The method for designing a fault detection circuit according to the second configuration is capable of dealing with a wide variety of target circuits.

In the method for designing a fault detection circuit according to the second configuration, the extraction step may include all of the first extraction step, the second extraction step, and the third extraction step (a third configuration).

The method for designing a fault detection circuit according to the third configuration is capable of dealing with a wider variety of target circuits.

In the method for designing a fault detection circuit according to any one of the first to third configurations, the extraction step may include the first extraction step, and the first index may be an index that corresponds to a number of faults detected by a two-signal implication relationship between the fixed signal value and a value of a third port (P3) of a logic gate (G21), the value of the third port P3 of the logic gate G21 serving as a condition for generating a new implication relationship between a first port (P1) and a second port (P2) of the logic gate (G21), a maximum number of faults detected by a two-signal implication relationship of which a starting point is the first port, and a maximum number of faults detected by a two-signal implication relationship of which a starting point is the second port (a fourth configuration).

In the method for designing a fault detection circuit according to any one of the first to fourth configurations, the extraction step may include the second extraction step, and the second index may be an index that corresponds to a number of faults detected by a two-signal implication relationship between the fixed signal value and a value of a third port (P3) of a logic gate, the value of the third port (P3) of the logic gate serving as a condition for generating a new implication relationship between a first port (P1) and a second port (P2) of the logic gate (G21) (a fifth configuration).

In the method for designing a fault detection circuit according to any one of the first to fifth configurations, the index may be an index corresponding to an occurrence probability of the fixed signal value (a sixth configuration).

What is claimed is:

1. A method for designing a fault detection circuit configured to detect a fault in a target circuit for fault detection, the method comprising:
an extraction step of selecting a fixed signal value based on an index, and extracting, by using the fixed signal value selected, one or some but not all of three-signal implication relationships that hold between nets in the target circuit; and
a designing step of designing the fault detection circuit by selecting an implication relationship that is high in area efficiency from among the three-signal implication relationships extracted in the extraction step and a two-signal implication relationship that holds between the nets in the target circuit,
wherein
the extraction step includes at least one of:
a first extraction step in which such ones of the three-signal implication relationships as have a fault-detection capability that is predictable from a number of faults detected by a two-signal implication relationship constitute a population for extraction, and the index is a first index which corresponds to a number of faults detected by three two-signal implication relationships;
a second extraction step in which such ones of the three-signal implication relationships as have a fault-detection capability that is partly predictable from a number of faults detected by a two-signal implication relationship constitute a population for extraction, and the index is a second index which corresponds to a number of faults detected by one two-signal implication relationship; and
a third extraction step in which such ones of the three-signal implication relationships as have a fault-detection capability that is unpredictable from a number of faults detected by a two-signal implication relationship constitute a population for extraction, and the index is a third index which corresponds to a number of implication relationships newly generated by the fixed signal value.

2. The method for designing a fault detection circuit according to claim 1, wherein
the extraction step includes at least two of the first extraction step, the second extraction step, and the third extraction step.

3. The method for designing a fault detection circuit according to claim 2, wherein
the extraction step includes all of the first extraction step, the second extraction step, and the third extraction step.

4. The method for designing a fault detection circuit according to claim 1, wherein
the extraction step includes the first extraction step, and
the first index is an index that corresponds to:
a number of faults detected by a two-signal implication relationship between the fixed signal value and a value of a third port of a logic gate, the value of the third port of the logic gate serving as a condition for generating a new implication relationship between a first port and a second port of the logic gate;
a maximum number of faults detected by a two-signal implication relationship of which a starting point is the first port; and
a maximum number of faults detected by a two-signal implication relationship of which a starting point is the second port.

5. The method for designing a fault detection circuit according to claim 2, wherein
the extraction step includes the first extraction step, and
the first index is an index that corresponds to:
a number of faults detected by a two-signal implication relationship between the fixed signal value and a value of a third port of a logic gate, the value of the third port of the logic gate serving as a condition for generating a new implication relationship between a first port and a second port of the logic gate;
a maximum number of faults detected by a two-signal implication relationship of which a starting point is the first port; and
a maximum number of faults detected by a two-signal implication relationship of which a starting point is the second port.

6. The method for designing a fault detection circuit according to claim 3, wherein
the extraction step includes the first extraction step, and
the first index is an index that corresponds to:
a number of faults detected by a two-signal implication relationship between the fixed signal value and a value of a third port of a logic gate, the value of the third port of the logic gate serving as a condition for generating a new implication relationship between a first port and a second port of the logic gate;
a maximum number of faults detected by a two-signal implication relationship of which a starting point is the first port; and
a maximum number of faults detected by a two-signal implication relationship of which a starting point is the second port.

7. The method for designing a fault detection circuit according to claim 1, wherein
the extraction step includes the second extraction step, and
the second index is an index that corresponds to
a number of faults detected by a two-signal implication relationship between the fixed signal value and a value of a third port of a logic gate, the value of the third port of the logic gate serving as a condition for generating a new implication relationship between a first port and a second port of the logic gate.

8. The method for designing a fault detection circuit according to claim 2, wherein
the extraction step includes the second extraction step, and
the second index is an index that corresponds to
a number of faults detected by a two-signal implication relationship between the fixed signal value and a value of a third port of a logic gate, the value of the third port of the logic gate serving as a condition for generating a new implication relationship between a first port and a second port of the logic gate.

9. The method for designing a fault detection circuit according to claim 3, wherein
the extraction step includes the second extraction step, and
the second index is an index that corresponds to
a number of faults detected by a two-signal implication relationship between the fixed signal value and a value of a third port of a logic gate, the value of the third port of the logic gate serving as a condition for generating a new implication relationship between a first port and a second port of the logic gate.

10. The method for designing a fault detection circuit according to claim 1, wherein
the index is an index that corresponds to an occurrence probability of the fixed signal value.

11. The method for designing a fault detection circuit according to claim 2, wherein
the index is an index that corresponds to an occurrence probability of the fixed signal value.

12. The method for designing a fault detection circuit according to claim 3, wherein
the index is an index that corresponds to an occurrence probability of the fixed signal value.
